(19) United States
(12) Patent Application Publication
(10) Pub. No.: US 2009/0300365 A1
(43) Pub. Date: Dec. 3, 2009

(54) Vehicle Diagnostic System Security with Memory Card

(76) Inventors: Robert Karmes, Delton, MI (US); Kevin Gray, Kalamazoo, MI (US); Scott Morris, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/129,992

(22) Filed: May 30, 2008

(51) Int. Cl. H04L 9/12

(52) U.S. Cl. 713/182

(57) ABSTRACT

A method and system are provided to authenticate a software stored on a computing device such as vehicle diagnostic tool. The system generates and stores encrypted information such as a memory media and the media access control address of the vehicle diagnostic tool. The encrypted information can be sent to an authentication server which returns encrypted authentication information that is used to validate the software for a period of time.

### FIELD OF THE INVENTION

The present invention relates generally to a vehicle diagnostic system. More particularly, the present invention relates to a vehicle diagnostic system with memory card authentication.

### BACKGROUND OF THE INVENTION

Vehicle diagnostic system includes software that is installed on a computing device such as a personal computer, PDA or a scan tool (collectively “vehicle diagnostic tool”). The software is used to diagnose problems with vehicles under test when the vehicle diagnostic tool is coupled to the vehicle's data link connector (“DLC”). The software contains diagnostic tests along with various databases of vehicle make, model, year and their respective diagnostic systems that have been collected and tested over a long period of time. Thus, the software can be as valuable or even more valuable than the vehicle diagnostic tool that it is installed on. This can lead to pirating of the software or unauthorized use of the software.

Accordingly, it is desirable to provide a vehicle diagnostic tool having diagnostic software and a method to ensure that the software running on vehicle diagnostic tool is authorized for that tool.

### SUMMARY OF THE INVENTION

The foregoing needs are met, to a great extent, by the present invention, wherein in one embodiment provides an apparatus and method that requires the computing device to authenticate the software via a remote authentication server.

In accordance with one embodiment of the present invention, a vehicle diagnostic system is provided, which can include a computing device configured to receive an external memory device and to communicate with a remote authentication server, wherein the external memory device has a serial number and the computing device has a media access control (MAC) address, a diagnostic software stored on the external memory device and the computing device, the diagnostic software configured to diagnose vehicle problems and provide updates to a vehicle's software, wherein each update to the vehicle's software is counted and encrypted, and encrypted information stored on the external memory device, wherein the encrypted information contains the serial number of the external memory device, the MAC address of the computing device, and the total count of the updates to the vehicle's software, the encrypted information is sent to an authentication server for authentication, and wherein the diagnostic software is validated based on at least part of the encrypted information.

In accordance with another embodiment of the present invention, a method to validate software installed on a vehicle diagnostic device is provided which can generate a memory device serial number using an operating system of the vehicle diagnostic device, encrypt the memory device serial number, store the encrypted memory device serial number on the memory device, determine a media access control (MAC) address of a wireless device in the vehicle diagnostic device, encrypt the MAC address, store the encrypted MAC address on the memory device, and validate a software stored on the vehicle diagnostic device for a first period of time by comparing the encrypted serial number with the serial number known by the computing device.

In accordance with yet another embodiment of the present invention, a vehicle diagnostic system is provided, which can include a computing device configured to receive an external memory device and to communicate with a remote authentication server, wherein the external memory device has a serial number and the computing device has a media access control (MAC) address, a diagnostic software stored on the computing device, the diagnostic software configured to diagnose vehicle problems and provide updates to a vehicle's software, wherein each update to the vehicle's software is counted and encrypted, and encrypted information stored on the external memory device, wherein the encrypted information contains the serial number of the external memory device, the MAC address of the computing device, and the total count of the updates to the vehicle's software and the encrypted information is sent to the authentication server for authentication.

In accordance with still another embodiment of the present invention, a vehicle diagnostic system is provided, which can include a means for computing configured to receive an external means for storing and to communicate with a means for authenticating a software, wherein the external means for storing has a serial number and the means for computing has a media access control (MAC) address, a diagnostic software stored on the means for computing, the diagnostic software configured to diagnose vehicle problems and provide updates to a vehicle's software, wherein each update to the vehicle's software is counted and encrypted, and encrypted information stored on the external means for storing, wherein the encrypted information contains the serial number of the external memory device, the MAC address of the means for computing, and the total count of the updates to the vehicle's software and the encrypted information is sent to the means for authenticating for authentication.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a system view illustrating a system according to an embodiment of the invention.

FIG. 2 illustrates the system having an authentication server.

FIG. 3 is a validation flow chart according to an embodiment of the invention.

### DETAILED DESCRIPTION

The invention will now be described with reference to the drawing figures, in which like reference numerals refer to like parts throughout. An embodiment in accordance with the present invention provides a vehicle diagnostic tool having diagnostic software that can be authenticated to ensure that the software is authorized for use on the tool. The software is stored on a memory card, such as a compact flash, secured digital, USB flash memory, memory stick and the like. In other embodiments, the software is stored on a CD and the memory card can be used to facilitate the authentication of the software.

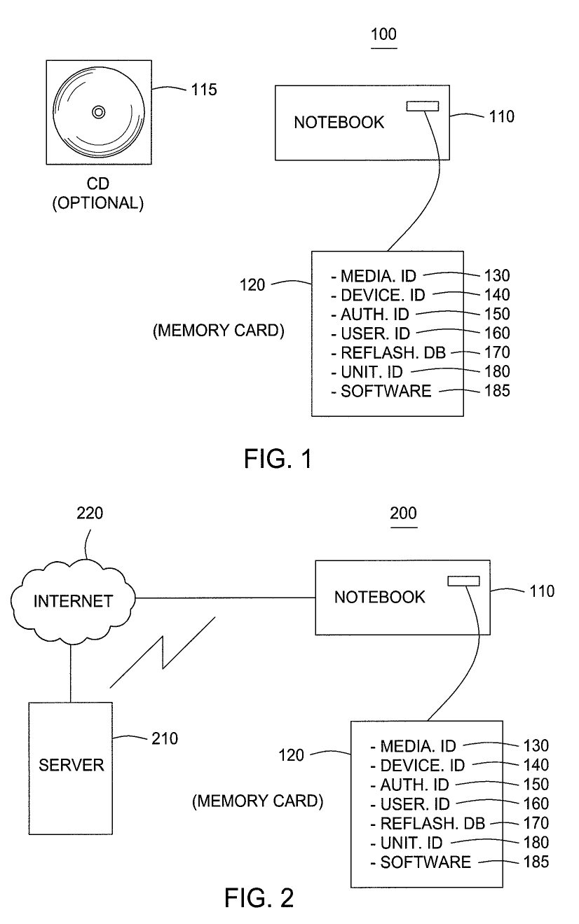

An embodiment of the present inventive system 100 is illustrated in FIG. 1, wherein a computing device 110 is configured to receive a memory card 120, or optionally a CD 115 or other similar computer readable medium such as a DVD (digital video disc). In one embodiment, the computing device is a notebook or a laptop, but may be any computing device including a personal computer, a scan tool, personal digital assistance, smartphone and the like. Additionally, in one embodiment, the memory card is a secure digital card (SD card) 120. The SD card can be 1G, 2G, 4G, 8G, 16G or any other memory size desired.

The SD card includes diagnostic software 185 (or optionally the software is on a CD) that has been previously purchased or ordered by an end user. In one embodiment, the end user is an employee of a vehicle's dealer. The diagnostic software 185 can include the full suite of modules, but having only certain portions that are “unlocked” or available for use by the computing device. In other embodiments, the diagnostic software 185 may be delivered having the full suite “unlocked” but then becomes “locked” for the modules that are not purchased after a period of time or could not be validated using the steps discussed below. In still other embodiments, additional modules may be “unlocked” by being purchased and authenticated, as the need arises. In one embodiment, the software has been previously loaded onto the computing device, but the SD card or the CD contains only the backup version.

In addition to storing the software 185, the SD card 120 may contain additional information in an encrypted format, such as a Media.ID 130, a Device.ID 140, an Auth.ID 150, a User.ID 160, a Reflash.DB 170 and a Unit.ID 180. These files are contained in a secure file system in the SD card and the file system resides on top of the Fat32 files systems (if the operating system of the computing device is Windows based such as, CE, XP or Vista). The Media.ID 130 is a unique serial number (for example, F8237123) assigned to the SD Card during the manufacturing process. In one embodiment, the varies ID files may be separate or combined together.

The Media.ID (further explained below) is used to further develop the Unit.ID 180 and the Auth.ID 150. The Device.ID 140 which is the wireless hardware's (located in the computing device 110) MAC (Media Access Control) address that uniquely identifies the computing device that the software 185 resides on and is used in developing the Unit.ID 180 file. An example of a Device.ID is 00:12:78:36:8F:52.

The Auth.ID 150 contains the Unit.ID 180 and the authentication validity time period and other information explained further below. The User.ID 160 contains the user type (technician, manager, etc.) and the dealer number. The Reflash.DB 170 contains information regarding the reflash of a dealer's software into a vehicle. The dealer's software can include software to run calibrations for tuning the vehicle and other parameters. By keeping count of the reflashes by the dealer, a report can be generated regarding the number of times the reflashes occur for accounting purposes.

As described above, at the beginning of the process a SD card 120 is inserted into a media reader/writer of the computing device 110. The Media.ID serial number is returned by the operating system that includes Windows CE, Windows XP, Linux, Apple OS X, Palm OS, etc. The Media.ID would be valid among the like platform units only. For example, if a Viewsonic PDA is used to initialized the SD card 120, then it would be valid on similar Viewsonic platforms but would not be valid on an HP iPaq PDA, for example. After the serial number is read by the computing device, it is encrypted and stored on a portion of SD card in the file “Media.ID” 130 or included in other files such as the Auth.ID file 150. The decryption key is known to the supplier as the SD card is often bundled with the computing device and shipped by the supplier to the end user. Once this occurs, the SD card is initialized and is valid on all similar hardware platforms. The Media.ID may be in the form of F8237123 or any other format assigned by operating system of the computing device. Once the SD card is initialized, the system 100 can be shipped to the user. The SD card 120 is configured so that the information stored therein cannot be copied or duplicated. The SD card 120 can also contain the software version on the computing device.

At this point, the software can be previously authorized to “fully function” (all modules “unlocked”) or be “partially unlocked” for a period of time. This allows the user to operate the computing device with the software once he receives it but before an authentication event with a remote authentication server can occur. This is beneficial when the user does not currently have access or the ability to communicate with the authentication server. The software can be allowed to function in any of the aforementioned modes (“unlocked” or “partially unlocked”) until a force or periodic authentication is mandated.

Once the user receives the system 100 that includes the computing device and registers the software, the Unit.ID is automatically created on the SD card. The Unit.ID is encrypted using the un-encrypted Media.ID as part of the encryption key. The computing device validates the SD card via the encrypted Media.ID file. If the validation fails, then the registration process will be halted and the user is prompted to replace the SD card with a valid card in order to proceed. Once the SD card is validated, the computing device queries its hardware for the wireless MAC (Media Access Control) address. If the MAC address can't be located or identified, the process is halted and the user is prompted to enable the wireless card or replace the computing device with a Wi-Fi equipped device. Once the MAC address is determined, an encrypted Unit.ID file is created on the SD card after the MAC address has been registered along with the dealer number. The Unit.ID is created on the Authentication Server (discussed below).

In one embodiment, next the User.ID file is created and encrypted on the SD card. The User.ID file contains the user type and the dealer number. The user type could be a technician, sales person, a manager or any other type of user. The dealer number is the number, previously assigned, of the dealer where the system was shipped or authorized to use the software and the computing device. The dealer number may be previously loaded onto the SD card, assigned by the authentication server, or entered by the user at registration. An example of dealer number is 7080 and the user type is technician.

In one embodiment, next the encrypted file “Auth.ID” is created on the SD card after authentication with the authentication server. The Auth.ID includes the Unit.ID and the Authentication validity time period or the time period in which the diagnostic software is valid and other information discussed further below.

TABLE 1

| Server Auth. | XJ1157 |
|---|---|
| Authentication Time Period: | 7 Days |
| Re-Flash Total Count: | 10 |
| Re-Flash Running Total: | 0 |
| Date and Time of Authentication: | 2/20/07 12:32 |
| Software Total Run Time since last Auth: | 26 hours |
| Date and Time of Last Software Start: | 2/6/07 13:48 |

Table 1 illustrates one embodiment of the Auth.ID, that includes the Server Authorization Code (server authorizes the software to function and provides an authorization code (ex. XJ1157)); authentication time period, which in this embodiment is seven days (time the software will be active until the next authentication); re-flash count (the number of re-flash that can be performed by the dealer on the vehicles, discussed further below); the re-flash running total (total number of re-flash, can be total number for the card for all time period or for a predetermined period such as authentication time period or any period); date and time of authentication; total run time since last authentication (total software run time since last authentication) and date and time of last start (date and time of last time computing device use).

TABLE 2

| | |
|---|---|
| Server Auth. | 1234567890123456 |
| Authentication Date & Time: | 03/16/2007 05:49 PM |
| Full Use Valid Until Date & Time: | 03/23/2008 05:49 PM |
| Limited Use Valid Until Date & Time: | 03/30/2007 05:49 PM |
| Date and Time of Last Software Start: | 03/16/2007 05:51 PM |
| Total Run Time (Minutes) since last | 10074 |
| Authentication: | |
| Reason for Last Authentication: | Expired Reflashes |

Table 2 illustrates another embodiment of the Auth.ID file that includes server authentication, authentication date and time; full use valid until date and time (this allows full use of all the software modules available in the software until that date and time, then a reauthentication is required for another full use); limited use valid until date and time (limited use of the software is authorized until that date and time, then a reauthentication is required for another limited use); date and time of last software start; total run time in minutes since last authentication; and reason for last authentication (expired reflash as shown above or reflashes). After the software is authenticated, the software can run on the computing device.

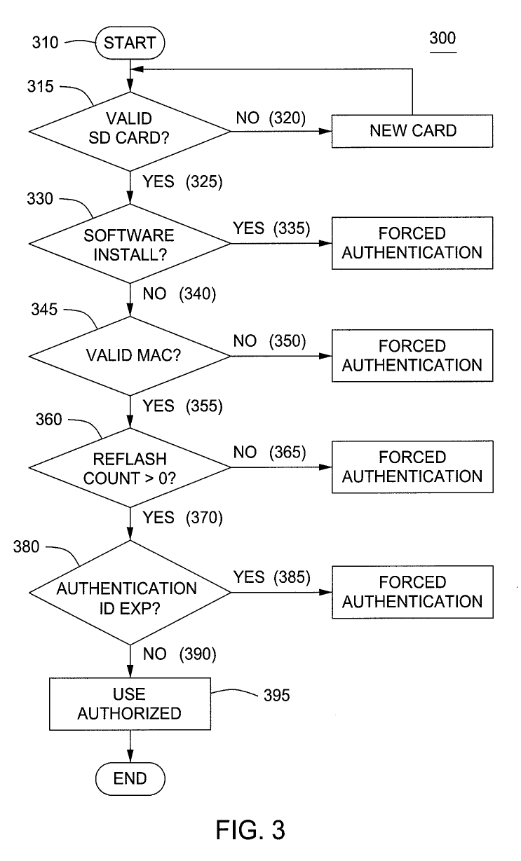

FIG. 3 illustrates a method 300 of validating the software according ton an embodiment of the invention. In operation, upon on start up of the software at step 310, the software, at step 315 determines the validity of the Media.ID file within the secure file system of the inserted SD card. If the SD card is invalid or no 320, then the user is notified and is requested to insert a valid SD card and the software shuts down and is locked down. In this locked down state, the software will not function even in the reduced functionality mode. This acts as a deterrent for unauthorized software copies, SD cards and computing devices. Once a new SD card is inserted, then proceed back to step 315 for validation of the SD card.

If the media check is valid or yes 325, then at step 330, then detect to see if this is a first install. During a first install the Auth.ID file and the User.ID file will not be present. If this is a first install, then the MAC address of the device is determined and stored in the Device.ID file then the user type and the dealer number are written to the User.ID file and an authentication is forced at step 335 (discussed further below). If no 340, then proceed to step 345.

If the media check is valid, then in another embodiment, the software detects if this is a new install at step 330 because the registry key that exists right after the install is present within the registry folder. Additionally, the database on the computing device will be out of sync with the database on the SD card (database mismatch). If this is a new install, an authentication is forced at step 335. If no 340, then proceed to step 345.

If the media check is valid, then in still another embodiment, the software, at step 345, compares the MAC address of the computing device to the Device.ID (having the authorized MAC address of the authorized computing device stored on the SD card) on the inserted SD Card. If they match 355, then the software proceeds to step 360. If they do not, then an authentication is forced at step 350.

After the Media.ID and the Device.ID are validated, then the software checks the re-flash count stored within the Auth.ID card at step 360. If the re-flash count is >0, or yes 370, then the software proceeds to step 380. If not 365, then an authentication is forced in order to reset the re-flash count. In another embodiment, the software compares the re-flash count stored secretly (on the on-board memory) on the computing device with the re-flash count on the SD card. If there is a mismatch, then an authentication is forced.

If the re-flash count is passed, then in one embodiment, the software tests Auth.ID for expiration at step 380. If the Auth.ID has not expired 390, then the software proceeds to step 395, if not, then an authentication is forced at step 385. The Auth.ID can be tested for validity by comparing the current date with the Authentication time period, the total run time, and the software last run date in order to detect any tampering with the system clock. Otherwise, by tampering with the system clock, the user can “trick” the software to believe that the expiration date of the authentication has not passed and continue to use the software. In another embodiment, if the user attempts to change the dealer number within the software, then an authentication is forced. At step 395, the software is allowed to be used or authorized for the authentication period of time.

FIG. 2 illustrates the system 100 along with an authentication server 210. The authentication server 210 is remotely located from the system 100. In one embodiment, the server 210 is located at the manufacturer's or supplier's facilities. However, the server 210 can be located anywhere and can be accessed via a wired or wireless connection including via the internet 220. The types of wireless connection include Wi-Fi, cellular, Bluetooth, satellite, infrared, WAN (wide area network) and other types of wireless communication.s

The server can be contacted due to a forced authentication as mentioned above. This means, the computing device is forced by the software to contact the server to authenticate or reauthenticate. This is in contrast to periodic authentication, which is a set time period in which the computing device contacts the server for authentication. In one embodiment, the computing device can contact the server twice daily. However, any other predetermined period can be used for periodic authentication.

An authentication (periodic and forced) involves sending one file, a certain number of files or all of the files located on the SD card to the authentication server. The files can be transferred via HTTPS and/or XML and returned in the same or different formats. Table 3 below illustrates the upload data according to an embodiment of the invention:

TABLE 3

| | |
|---|---|
| Dealer Number: | 7090 |
| Device ID: | 00:02:78:54:8F:9A (From |
| | Device - Not Card) |
| Media ID: | 40237BFD (From SD Card) |
| Server Auth.: | XJ1157 (last Auth Code Read |
| | from SD Card) |
| Re-Flash Total Count: | 10 |
| Re-Flash Running Total | 0 |
| Date and time of last Authentication: | 2/3/07 10:34 |
| Date and Time of Last DT Start: | 2/6/07 13:48 |
| Software Total Run Time since last Auth: | 26 hours (From SD Card) |
| Software Detected Reason: | Renew |
| User Level: | Technician (Read form |
| | User.ID file on SD Card) |
| Device Type: | Laptop |
| Computer Name: | George |

From Table 3, the dealer number can be either the previously assigned dealer number or number to be assigned by the server. The server may respond with a dealer number if a change is required such as with a device transfer from one dealer to another. In the case of the number to be assigned, the server responds with the dealer actual number once it has been assigned. The Device.ID read from the MAC address of the computing device is compared with the Auth.ID number on file along with the Media.ID number and can thereby detect if the user wants to transfer authentication to a new computing device. Server Auth. is the last authentication code stored on the SD card that was sent from the server and compared to the one stored on the server to discover fraud activities.

In the event of a new install, the code will be “new.” The re-flash total count for the current user is sent to the server and compared for fraud. This value can change based on various user levels. Re-flash running count is the highest recorded re-flash running count from the SD card and the secret file stored on the computing device's memory. The server will compare the count to the information on the sever to detect any fraud. Date and time of last authentication is compared to the information on the server to detect fraud. Similarly, the date and time of the last software start is compared to information on the server to detect fraud. Software detected reason is why the authentication was initiated. Valid reasons include new install, first install, authentication renewal, dealer change, device transfer, etc. This helps the sever to identify why the authentication is occurring and can help to prevent fraud. User level is the information read from the User.ID file on the SD card. Device type can be ascertained by the software by using the Dotnet framework. Computer name is determined by the software through the appropriate Windows API call.

The return by the server to the computing device can include information such as:

Server Auth: 12821392781375642

Reflash Total: 10

Auth Date and Time: 4/18/08 2:20:12 PM

Full Valid Date and Time: 4/25/08 2:20:12 PM

Limited Valid Date and Time: 5/2/08 2:20:12 PM

Reason: Ping

The server authentication is the record identification stored in an SQL table for the current authentication. Reflash Total is the total number of re-flashes allowed during the authentication time period before a forced authentication occurs. In one embodiment, the re-flash total can change with user types. When the software receives the total count, it stores it on the SD card and resets the running total to zero. The authentication date and time is the time and date that the authentication occurred. The full valid date and time is the time period in which the software is allowed to be run at the fully “unlocked” state or at the full version. In this embodiment, the time period is a week before a forced authentication has to occur for the software to be in this state. The limited valid date and time are typically longer than the full valid date and time. This would mean that the software is not fully functional and that part of its software is “unlocked” for this amount of time.

In other embodiments of the invention, the Auth.ID file now includes the Media.ID and the Device.ID files. The Media.ID can also contain the billing data that has not been synchronized with the authentication server. The billing data is the information on how much reflashes have been conducted since the last authentication. The billing information may be used to charge the dealer for the number of vehicle calibrations or software updates. In other embodiments, the Device.ID does not contain information about the device, but could contain any other information desired by the user.

In some embodiments, the software and server may exchange the following types of information: Server Authentication, Dealer number, Device. ID, Media.ID, Reflash total, reflash count, user level, device type, computer name, reason for authentication, authentication date and time, full valid date and time, limited valid date and time, last start date and time, run time, region (region (North America, Asia, etc.) of the world dealer is located), Country, Distributor number, State, Dealer Type, Serial Number (serial number assigned by the manufacturer of the SD card), synchindentifier, key serial number (serial number of the software) and software version.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A vehicle diagnostic system, comprising:
a computing device configured to receive an external memory device and to communicate with a remote authentication server, wherein the external memory device has a serial number and the computing device has a media access control (MAC) address;
a diagnostic software stored on the external memory device and the computing device, the diagnostic software configured to diagnose vehicle problems and provide updates to a vehicle's software, wherein each update to the vehicle's software is counted and encrypted; and
encrypted information stored on the external memory device, wherein the encrypted information contains the serial number of the external memory device, the MAC address of the computing device, and the total count of the updates to the vehicle's software, the encrypted information is sent to an authentication server for authentication, and wherein the diagnostic software is validated based on at least part of the encrypted information.

2. The system of claim 1, wherein the software does not function if the authentication server can not authenticate the encrypted information.

3. The system of claim 1, wherein the encrypted information further comprises a dealer identification number and regional information.

4. The system of claim 1, wherein the software is allowed to perform at limited functionality if the authentication server can not authenticate the encrypted information.

5. The system of claim 1, wherein the external memory device is configured so that if it is duplicated, the information stored on the external media device can not be used to authorized the software.

6. The system of claim 1, wherein the software is configured to cause a forced authentication after a predetermined event.

7. The system of claim 6, wherein the predetermined event includes a first installation of the software and a new installation of the software on the computing device.

8. The system of claim 1, wherein the authentication server returns encrypted authentication information that the computing device stores on the external media device and is used to validate the software for a predetermined period of time.

9. The system of claim 1, wherein the software is configured to cause a periodic authentication after a predetermined period of time.

10. The system of claim 1, wherein the software is configured to determine if the encrypted serial number stored on external media device is valid, if not, then the software does not function or function at limited functionality.

11. The system of claim 8, wherein the encrypted authentication number includes a server authentication code and the authentication date and time.

12. The system of claim 8, wherein the encrypted authentication number includes full valid date and time and limited valid and time.

13. A method to validate software installed on a vehicle diagnostic device, comprising the steps of:
generating a memory device serial number using an operating system of the vehicle diagnostic device;
encrypting the memory device serial number;
storing the encrypted memory device serial number on the memory device;
determining a media access control (MAC) address of a wireless device in the vehicle diagnostic device;
encrypting the MAC address;
storing the encrypted MAC address on the memory device; and
validating a software stored on the vehicle diagnostic device for a first period of time by comparing the encrypted serial number with the serial number known by the computing device.

14. The method of claim 13 further comprising:
sending the encrypted information stored on the memory device to an authentication server;
receiving encrypted authentication information from the authentication server; and
validating the software for a second period of time based on the authentication information.

15. The method of claim 14, wherein the authentication information includes an authentication code, full use valid until date and time and limited use valid until date and time.

16. The method of claim 14, wherein the authentication information includes date and of a last software start and total run time of the software since the last authentication.

17. The method of claim 13 further comprising:
entering a user identification based on a type of user of the vehicle diagnostic device onto the memory device;
entering a dealer number; and
validating the software for a second period of time based on user identification and the dealer number.

18. The method of claim 13 further comprising:
forcing a validation with the authentication server after a predetermined event.

19. The method of claim 13 further comprising:
Forcing a validation after a predetermined period of time has passed.

20. A vehicle diagnostic system, comprising:
a computing device configured to receive an external memory device and to communicate with a remote authentication server, wherein the external memory device has a serial number and the computing device has a media access control (MAC) address;
a diagnostic software stored on the computing device, the diagnostic software configured to diagnose vehicle problems and provide updates to a vehicle's software, wherein each update to the vehicle's software is counted and encrypted; and
encrypted information stored on the external memory device, wherein the encrypted information contains the serial number of the external memory device, the MAC address of the computing device, and the total count of the updates to the vehicle's software and the encrypted information is sent to the authentication server for authentication.

21. A vehicle diagnostic system, comprising:
a means for computing configured to receive an external means for storing and to communicate with a means for authenticating a software, wherein the external means for storing has a serial number and the means for computing has a media access control (MAC) address;
a diagnostic software stored on the means for computing, the diagnostic software configured to diagnose vehicle problems and provide updates to a vehicle's software, wherein each update to the vehicle's software is counted and encrypted; and
encrypted information stored on the external means for storing, wherein the encrypted information contains the serial number of the external memory device, the MAC address of the means for computing, and the total count of the updates to the vehicle's software and the encrypted information is sent to the means for authenticating for authentication.
